(19) United States
(12) Patent Application Publication
(10) Pub. No.: US 2007/0258692 A1
(43) Pub. Date: Nov. 8, 2007

(54) Lawn maintenance cable guard

(76) Inventor: Richard Wayne Rogers, Katy, TX (US)

Correspondence Address: CHARLES SARON KNOBLOCH, 1519 MISSION SPRINGS, KATY, TX, 77450, US

(21) Appl. No.: 11/382,201

(22) Filed: May 8, 2006

(51) Int. Cl. G02B 6/00

(52) U.S. Cl. 385/134

(57) ABSTRACT

A cable guard or means (with or without a decorative cap) of protecting wiring, cable lines, cable TV lines, phone lines, satellite cables, and yard lighting wires from damage caused by lawn maintenance equipment, covering the cable above the ground and below the ground, and can be secured to the wall or foundation or not, preventing the wire or cable from being damaged by lawn maintenance equipment.

### BACKGROUND OF THE INVENTION

1. Field of the Invention

The present invention generally relates to a device used to protect cables or wires from lawn maintenance equipment.

2. Description of the Related Art

A vast majority of structures have delicate cables or wires coming out or going into them. These wires consist of cable TV, Satellite cable, phone lines, and low voltage wires. Often when mowing or trimming the yard, these cables or wires get tangled up, cut in half, or pulled out of the ground. This cable guard will be placed over the cable or wire to be protected (FIG. 1, 102 and FIG. 2, 201), the cable guard will then be tapped into the ground about two inches, then secured to the structure using the anchor strap (FIG. 1, 107 and FIG. 2, 201).

### SUMMARY OF THE INVENTION

A cable guard or means (with or without a decorative cap) of protecting wiring, cable lines, cable TV lines, phone lines, satellite cables, and yard lighting wires from damage caused by lawn maintenance equipment, covering the cable for approximately 8″ above the ground and 2″ below the ground, and is secured to the wall or foundation by a strap, preventing the wire or cable from being damaged by lawn mowers and weed trimmers. The cable guard may be manufactured out of PVC plastic, steel pipe, wood, masonry, or other materials with sufficient hardiness to protect the cable or wire.

### BRIEF DESCRIPTION OF THE DRAWINGS

FIG. 1: 100—Front view showing the opening at the bottom that is placed over the cable or wire as the cable guard is being tapped into the ground.

101—Side view showing the wedge cut at the bottom of the cable guard, which is a passive means to push the device closer to the structure as the cable guard is being tapped into the ground.

102—Rear view showing the opening running the full length of the cable guard, used to place the device over the cable or wire for protection.

103—Top view showing the opening used to place the device over the cable or wire for protection.

104—Top view of optional cap, showing the opening for being placed around the cable or wire, while being placed over the top of the cable guard.

105—Side view of optional cap.

106—Top view of anchor strap, used to secure the device to the structure.

107—Side view of anchor strap.

FIG. 2: 200—Front view of cable guard as used to protect a cable or wire. This view shows how the cable guard would be inserted into the ground several inches, while having enough of the cable guard above ground to adequately protect the cable or wire.

201—Side view of cable guard as used to protect a cable or wire. This view shows how the cable guard would be secured to the structure.

1. A cable guard or means (with or without a decorative cap) of protecting wiring, cable lines, cable TV lines, phone lines, satellite cables, and yard lighting wires from damage caused by lawn maintenance equipment.

2. Cable guard as claimed in claim 1, wherein a cap is selectably disposed thereon.

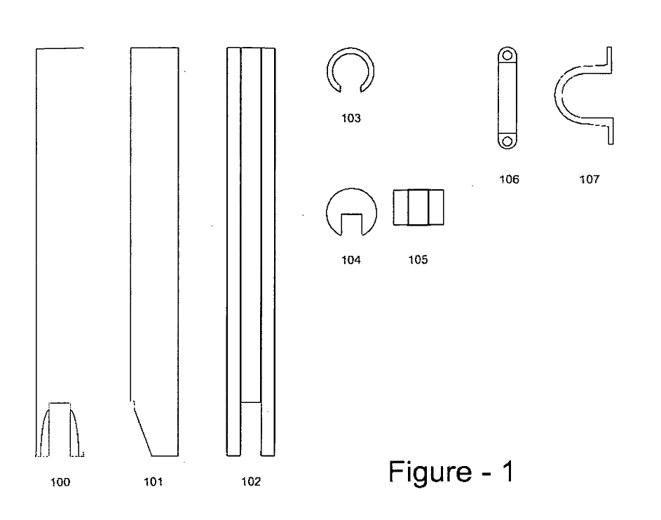

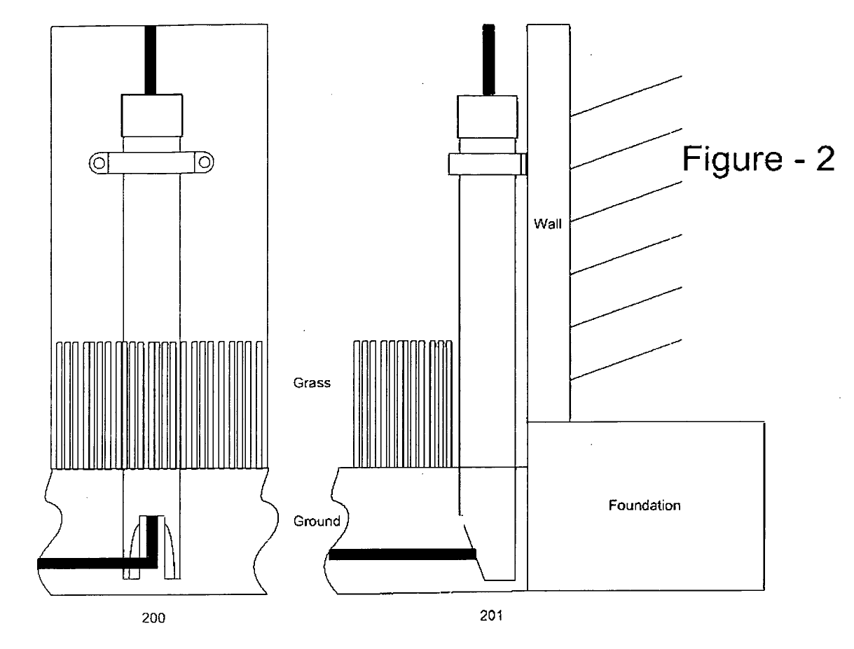

3. Cable guard as claimed in claim 1, having a means of forcing the cable guard against the structure while being inserted into the ground (as shown in FIG. 1, 101).

4. Cable guard as claimed in claim 1, having an opening down one side allowing for the cable guard to be placed over the cable or wire in a protective manner.

5. Cable guard as claimed in claim 1, having a means of securing the device to a structure (as shown in FIG. 1, 107).

6. A device for protecting wiring from damage caused by lawn maintenance equipment, the device comprising:
a cable guard;
a first opening disposed at the bottom of said cable guard;
a wedge cut disposed at the bottom of said cable guard;
a second opening disposed down one side of said cable guard; and
an anchor strap, said anchor strap shaped to receive said cable guard.

7. A device for protecting wiring from damage caused by lawn maintenance equipment, the device comprising:
means for protecting a wire;
a first opening disposed at the bottom of said protection means;
means for forcing the device against a structure while the device is being inserted into the ground;
a second opening disposed down one side of said protection means; and
means for securing the device to a structure, said securing means shaped to receive said protection means.

8. The device of claim 7 wherein said means for protecting a wire comprise a cable guard.

9. The device of claim 7 wherein said means for forcing the device against a structure comprise a wedge cut disposed at the bottom of said protection means.

10. The device of claim 7 wherein said means for securing the device to a structure comprise an anchor strap, said anchor strap shaped to receive said cable guard.
